(19) United States
(12) Patent Application Publication
(10) Pub. No.: US 2020/0041082 A1
(43) Pub. Date: Feb. 6, 2020

(54) Adaptive Ambiance Lighting

(71) Applicant: Eaton Intelligent Power Limited, Dublin 4 (IE)

(72) Inventors: Pengseng Tan, Peachtree City, GA (US); Nam Chin Cho, Peachtree City, GA (US); Parth Joshi, Atlanta, GA (US)

(21) Appl. No.: 16/529,436

(22) Filed: Aug. 1, 2019

Related U.S. Application Data
(60) Provisional application No. 62/714,340, filed on Aug. 3, 2018.

(51) Int. Cl. F21S 10/02; G06T 7/90; F21S 8/04; F21V 14/00; H05B 33/08

(52) U.S. Cl. CPC F21S 10/02; G06T 7/90; F21S 8/04; F21Y 2115/10; H05B 33/0854; H05B 33/0872; F21V 14/00

(57) ABSTRACT

A lighting fixture includes a light source configured to emit a light toward an area. The lighting fixture further includes a receiver configured to receive an image of the area. The lighting fixture also includes a controller device configured to adjust a color or a color temperature of the light emitted based on at least color content of the image.

### CROSS REFERENCE TO RELATED APPLICATIONS

The present application claims priority under 35 U.S.C. Section 119(e) to U.S. Provisional Patent Application No. 62/714,340, filed Aug. 3, 2018 and titled “Adaptive Ambiance Lighting,” the entire content of which is incorporated herein by reference.

### TECHNICAL FIELD

The present disclosure relates generally to lighting-related solutions, and more particularly to lighting control based on an area that is illuminated by a light.

### BACKGROUND

The appearance of objects in an area can depend on the lighting condition of the area. For example, different objects typically have different colors and may have appearances that depend on the lighting of the area. Although the light provided by some lighting fixtures may be adjustable for dim level, color temperature, etc., these lighting fixtures typically provide light independent of the colors of objects present in the illuminated area. For example, a lighting fixture is typically controlled to emit a brighter light during the day time and a dim light during the evening independent of the color of objects in a room. In some cases, adjustments of lighting characteristics such as dim level, color temperature, and/or color based on the colors of objects in an area may result in an enhanced and/or a more desirable appearance of the area. Thus, a solution that enables the adjustment of a light based on the color content of an area may be desirable.

### SUMMARY

The present disclosure relates generally to lighting-related solutions, and more particularly to lighting control based on an area that is illuminated by a light. In an example embodiment, a lighting fixture includes a light source configured to emit a light toward an area. The lighting fixture further includes a receiver configured to receive an image of the area. The lighting fixture also includes a controller device configured to adjust a color or a color temperature of the light based on at least color content of the image.

In another example embodiment, a lighting fixture includes a light source configured to emit a light toward an area. The lighting fixture further includes a camera configured to capture an image of the area. The lighting fixture also includes a controller device configured to adjust a color or a color temperature of the light based on at least color content of the image.

In another example embodiment, a method of adjusting a light provided by a lighting fixture includes receiving, by a lighting fixture, an image of an area and determining, by a controller device of the lighting fixture, a color content of the image. The method further includes adjusting, by the controller device of the lighting fixture, a color of the light or a color temperature of the light based on the color content of the image.

These and other aspects, objects, features, and embodiments will be apparent from the following description and the claims.

### BRIEF DESCRIPTION OF THE FIGURES

Reference will now be made to the accompanying drawings, which are not necessarily drawn to scale, and wherein:

FIG. 1 illustrates a lighting system including a lighting fixture with a lighting adjustment capability based on an illuminated area or object according to an example embodiment;

FIG. 2 illustrates a block diagram of the lighting fixture of FIG. 1 according to an example embodiment;

FIG. 3 illustrates a lighting system including a lighting fixture with a lighting adjustment capability based on an illuminated area according to another example embodiment;

FIG. 4 illustrates a block diagram of the lighting fixture of FIG. 3 according to an example embodiment;

FIG. 5 illustrates a method of lighting adjustment based on an illuminated area according to an example embodiment; and

FIG. 6 illustrates a method of lighting adjustment based on an illuminated area according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals that are used in different drawings designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

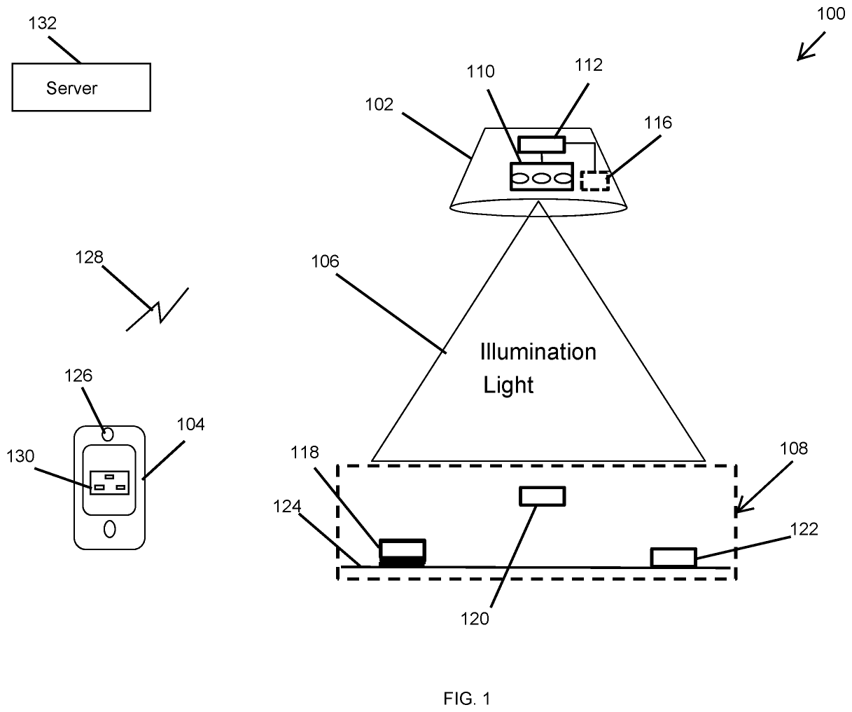

Turning now to the figures, example embodiments are described. FIG. 1 illustrates a lighting system 100 including a lighting fixture 102 with a lighting adjustment capability based on an illuminated area 108 or object according to an example embodiment. In some example embodiments, the lighting system 100 includes a lighting fixture 102 and a control device 104. The lighting fixture 102 may provide an illumination light 106 to the area 108. To illustrate, the lighting fixture 102 may include a light source 110 and a controller device 112 that controls the light source 110. The light source 110 may include light emitting diodes (LEDs) that emit the light 106.

In some example embodiments, the light source 110 may be capable of emitting the light 106 such that the light 106 has particular color content, color temperature and/or dim level. For example, the light source 100 may include different groups of LEDs that emit different lights having different colors, color temperatures, dim levels, etc. To illustrate, the light source 100 may include one or more LEDs that emit a red light, one or more LEDs that emit a green light, one or more LEDs that emit a blue light, etc. Alternatively or in addition, the light source 100 may include one or more LEDs that emit a white light having a first color temperature, one or more LEDs that emit another white light having a second color temperature, etc. The illumination light 106 may be one of the lights emitted by one or more of the LEDs or may be a combination of the lights emitted by different groups of one or more LEDs depending on the desired characteristics of the light 106.

In some example embodiments, the controller device 112 may control the light source 110 to set and/or adjust the characteristics of the light 106. For example, the controller device 112 may control the amount of power provided to different groups of LEDs of the light source 110 to achieve the desired characteristics of the light 106. To illustrate, the controller device 112 may control the amount of current that is provided to or that flows through individual groups of LEDs of the light source 110 by controlling a driver that provides power to the light source 110 or by controlling the current path of the individual group of LEDs.

The lighting fixture 102 may also include an auxiliary light source 116 that may emit a light that is provided by the lighting fixture 102 as the light 106 or that is combined with one or more other lights from one or more groups of LEDs of the light source 110. For example, the auxiliary light source 116 may include one or more LEDs that emit a light having a color and/or color temperature that is different from those of the light or lights emitted by the LEDs of the light source 110. The controller device 112 may control the light emitted by the auxiliary light source 116 by controlling the amount of power provided to the auxiliary light source 116.

In some example embodiments, the controller device 112 may control the light source 110 to adjust the light 106 based on the color content of the area 108. To illustrate, the illuminated area 108 may include objects 118, 120, 122, a floor 124, and a wall or walls, etc. The objects 118, 120, 122, the floor 124, walls, etc. may have similar or different colors from each other. Lights from other sources (e.g., a television screen, a display monitor, etc.) and direct or indirect sunlight may also be present in the area 108. The controller device 112 may control the light source 110 to adjust the color or colors, a color temperature, etc. of the light 106 to produce an enhanced or desirable appearance of the area 108 overall or particular objects in the area 108.

In some example embodiments, the controller device 112 may process an image 130 (e.g., an image of the area 108, an image showing mostly an object, such as the object 118, in the area 108, etc.) to determine the color content of the image, and thus, of the area 108. To illustrate, the controller device 112 may receive the image 130 from the control device 104 (e.g., a mobile phone, a tablet, etc.). The control device 104 may include a camera 126 that can capture the image 130. For example, a user may provide an input to the control device 104 to capture the image 130 of the area 108 or of an object, and the control device 104 may capture and send the image 130 to the lighting fixture 102 in response to the user input. The control device 104 may transmit the image 130 to the lighting fixture 102, for example, using a wireless signal 128 or a wireline signal. For example, the wireless signal 128 may be a Bluetooth signal, a ZigBee signal, a proprietary signal, or a wireless signal that is complaint with another communication standard.

In some example embodiments, the process of adjusting the light 106 based on the characteristics of the area 108 may be initiated by the control device 104, for example, in response to a user input. For example, the control device 104 may send a message/command (e.g., via a Bluetooth signal) to the lighting fixture 102 to start the process of adjusting the light 106 based on the characteristics of the area 108. The control device 104 may send the image 130 to the lighting fixture 102 after or along with the message/command that initiates the process of adjusting the light 106.

In some example embodiments, in response to receiving the message/command to start the light adjustment process, the lighting fixture 102 may adjust the light 106 to be self-aligned (i.e., such that the light 106 is a balanced light with low impact on the image 130 captured by the camera 126). The camera 126 of the control device 104 may capture and send the image 130 to the lighting fixture 102 after giving the lighting fixture 102 adequate time (e.g., 1 minute) to change the light 106 such that the light 106 has neutral/balanced characteristics. The controller device 112 of the lighting fixture 102 may receive and process the image 130 to determine the color content of the image 130. In some example embodiments, instead of adjusting the light 106 to be self-aligned, the lighting fixture 102 may turn off the light 106 and emit a light by the auxiliary light source 116 before capturing the image 130 using the camera 126. For example, the auxiliary light source 116 may already be configured to emit a light that has neutral/balanced characteristics to illuminate an area/scene.

In some example embodiments, the controller device 112 may determine the color content of the image 130 by detecting some colors that are present in the image 130. For example, the controller device 112 may detect the most dominant colors (e.g., the two most dominant colors, the three most dominant colors, etc.) that are present in the image 130 and the amount of each dominant color (e.g., in percentage terms from among all of the dominant colors). As another example, the controller device 112 may detect red, green, and blue (RGB) colors in the image 130 and the amount of each RGB color (e.g., a percentage red color, a percentage of green color, a percentage of blue color from among all of the RGB colors). In some example embodiments, the controller device 112 may apply color masks to detect the presence of different colors and to determine the amounts of the colors in the image 130 and may generate a histogram or equivalent information.

In some example embodiments, after determining the color content of the image 130, the controller device 112 may control the light source 110 to control the dim level, the color, and/or the color temperature of the light 106 based on the color content of the image 130. For example, the controller device 112 may control the light source 110 to adjust the light 106 according to a particular lighting/color rule that may be, for example, stored in or accessible by the controller device 112. For example, one or more lighting/color adjustment rules may be stored as a lookup table in the controller device 112.

To illustrate, if the controller device 112 determines that a particular color is the most dominant color, the controller device 112 may control the light source 110 such that the light 106 has a particular dim level, a particular color, or a particular color temperature based on the lighting/color rule. For example, if the controller device 112 determines that red is more than 70% of the RGB colors detected in the image 130, the controller device 112 may control the light source 110 such that the light 106 is dominated by a cyan color. As another example, the light 106 may be adjusted to have a color temperature of 4500K if the controller device 112 determines that blue is more dominant than other colors in the image 130. In general, additive, complementary or other color mixing and lighting rules may be applied by the controller device 112 to adjust the light 106 based on the color content of the image 130. The color temperature and/or dim level of the light 106 may also be adjusted based on similar lighting rules. In some example embodiments, the controller device 112 may control the auxiliary light source 116 in a similar manner as described with respect to the light source 110 to achieve the desired characteristics of the light 106.

By setting or adjusting the characteristics of the light 106 based on the color content of the area 108 as determined from the image 130 of the area 108, the appearance of the area 108 may be enhanced or changed to be more desirable. By setting or adjusting the characteristics of the light 106 based on the color content of an object as determined from the image 130 of the object, the appearance of the object may be enhanced or changed to be more desirable.

In some alternative embodiments, the lighting fixture 102 or the control device 104 may send the image 130 to a local or remote (e.g., cloud) server 132 for processing of the image 130 to determine the color content of the image 130, and thus, that of the area 108. For example, the server 132 may process the image 130 and send color content information to the lighting fixture 102, and the controller device 112 may adjust the characteristics of the light 106 based on the color content and the lighting/color rules. In some example embodiments, the server 132 may determine the characteristics that the light 106 should have based on the color content determined from the image 130 and the lighting/color rules. The server 132 may send the color, color temperature and/or intensity values/setting to the lighting fixture 102, and the controller device 112 may adjust the characteristics of the light 106 based on the values/setting received from the server 132.

In some alternative embodiments, instead of sending the image 130 to the lighting fixture 102, the control device 104 may process the image 130 to determine the color content in the same manner as described above. For example, the control device 104 may include a processor or a controller that performs the operations described above with respect to the controller device 112 to determine the color content of the image 130. After determining the color content of the image 130, the control device 104 may send color content information (e.g., the percentage of red, the percentage of blue, . . . from among a number of colors, a normalized indicator of one or more colors, etc.) to the light source 110. The controller device 112 may control the light source 110 to adjust the light 106 according to color content information received from the control device 104. Alternatively, after determining the color content of the image 130, the control device 104 may send lighting adjustment message/command to the light source 110, and the controller device 112 may control the light source 110 to adjust the light 106 according to the lighting adjustment message/command.

In some example embodiments, the image 130 may be dominated by an object (e.g., the object 120), and the controller device 112 may adjust the light 106 to enhance the appearance of the particular object. In some example embodiments, the auxiliary light source 116 may be omitted. In some alternative embodiments, the control device 104 may be a wall mounted device. The area 108 may have a different shape and may have more or fewer objects than shown without departing from the scope of this disclosure. In some example embodiments, the lighting fixture 102 may include other components and/or may have components that are configured in a different manner than shown without departing from the scope of this disclosure.

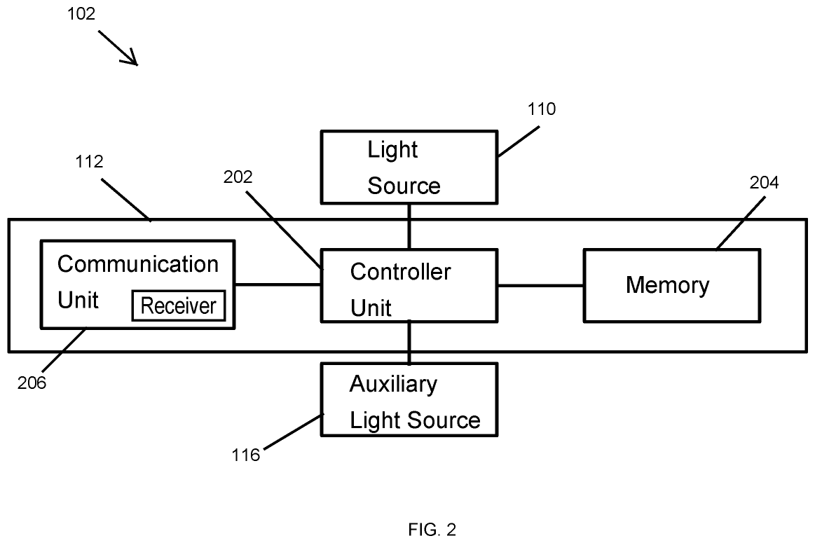

FIG. 2 illustrates a block diagram of the lighting fixture 102 of FIG. 1 according to an example embodiment. Referring to FIGS. 1 and 2, in some example embodiments, the lighting fixture 102 includes the light source 110 and the controller device 112. The lighting fixture 102 may also include the optional auxiliary light source 116. The controller device 112 may include a controller unit 202, a memory device 204 (e.g., a non-volatile memory), and a communication unit 206. For example, the controller unit 202 may include a microcontroller or a microprocessor that can execute software code to perform operations performed by the controller device 112.

In some example embodiments, the executable software code may be stored in the memory device 204 (e.g., a flash memory). Lighting/color rules may also be stored in the memory device 204 and may be accessed by the controller unit 202 to control the light source 110 and/or the auxiliary light source 116 to adjust the light 106 based on the color content of the image 130. The communication unit 206 may include one or more receivers, transmitters, and/or transceivers that can receive and transmit signals wirelessly or via wired connections. For example, the communication unit 206 may receive the image 130 from the control device 104 and provide the image 130 to the controller unit 202 for processing to determine the color content of the image 130.

In some example embodiments, the communication unit 206 may also transmit and receive signals carrying information, such as the image 130, to and from the server 132. For example, the controller unit 202 may use the communication unit 206 to transmit the image 130 and to receive color content of the image 130 determined by the server 132.

In some example embodiments, the lighting fixture 102 may have more or fewer components than shown without departing from the scope of this disclosure. For example, the lighting fixture 102 may include a driver that provides power to the light sources 110 and 116. In some alternative embodiments, the components of the lighting fixture 102 may have a different configuration than shown without departing from the scope of this disclosure. In some example embodiments, some components of the lighting fixture 102 may be integrated into a single component without departing from the scope of this disclosure.

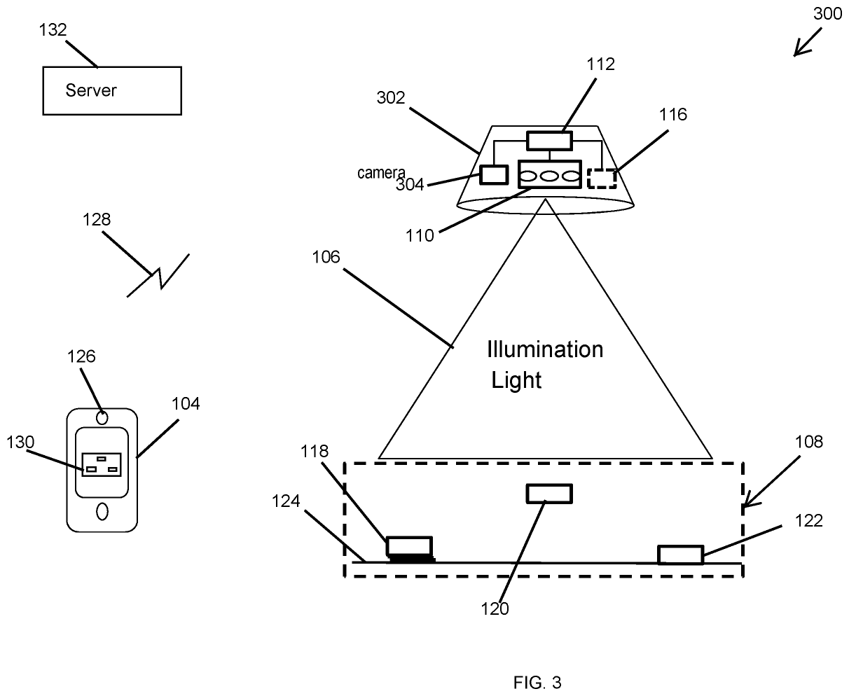

FIG. 3 illustrates a lighting system 300 including a lighting fixture 302 with a capability of lighting adjustment based on an illuminated area or object according to another example embodiment. In general, the system 300 operates in a similar manner as the system 100. Focusing on the main differences, the lighting system 300 includes the lighting fixture 302 and the control device 104. The lighting fixture 302 may include a camera device 304 that can capture an image of the area 108 or of one or more objects, such as the object 118, 120, 122. For example, the controller device 112 may receive the image of the area 108 from the camera device 304 and process the image to determine the color content of the image, and thus, that of the area 108, in a similar manner as described with respect to FIGS. 1 and 2. Alternatively or in addition, the controller device 112 of the lighting fixture 302 may receive the image 130 of the area 108 from the control device 104 and process the image to determine the color content of the image as described with respect to FIGS. 1 and 2.

The controller device 112 may control the light source 110 to adjust the light 106 based on the color content of the image received from the camera 304 and lighting/color rules in a similar manner as described above. For example, the controller device 112 may control the light source 110 to change the dim level, the color and/or color temperature of the light 106 based on the color content of the image of the area 108 or of an object (e.g., the object 118) in the area 108 and lighting/color rules stored in the controller device 112.

In some example embodiments, the control device 104 may send a message/command to the lighting fixture 302 to initiate the color adjustment process. For example, the control device 104 may send the message/command via the wireless signal 128, for example, in response to a user input provided to the control device 104. The camera 304 may capture he image of the area 108 or of an object in the area 108 in response to receiving the process initiating message/command from the control device 104. Before capturing the image, the lighting fixture 110 may adjust the light 106 to have neutral/balanced characteristics in order to limit the impact of the light 106 on the image captured by the camera 304. For example, lighting parameters that correspond to neutral/balanced characteristics of the light 106 may be stored in the memory device of the lighting fixture 302, and the controller device 112 may adjust the light 106 based on the stored parameters.

In some alternative embodiments, the lighting fixture 302 may send the image 130 to the local or remote (e.g., cloud) server 132 for processing of the image 130 to determine the color content of the image, and thus, that of the area 108 or a particular object dominating the image. For example, the server 132 may process the image 130 and send color content information to the lighting fixture 302, and the controller device 112 may adjust the characteristics of the light 106 based on the color content and the lighting/color rules.

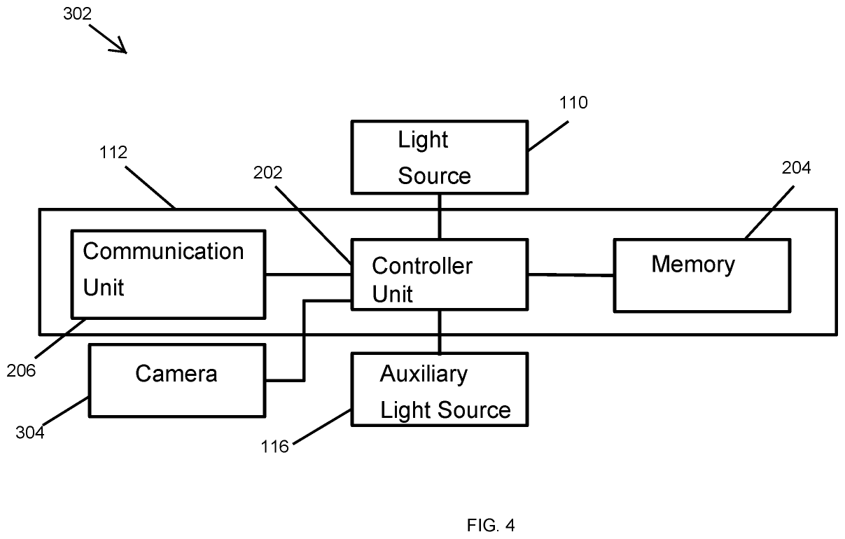

FIG. 4 illustrates a block diagram of the lighting fixture 302 of FIG. 3 according to an example embodiment. Referring to FIGS. 1-4, in some example embodiments, the lighting fixture 302 includes the light source 110, the controller device 112, and the camera 304. The lighting fixture 102 may also include the optional auxiliary light source 116. In some example embodiments, the lighting fixture 302 corresponds to the lighting fixture 102 of FIGS. 1 and 2 with the addition of the camera 304.

In some example embodiments, the controller device 112 may receive the image captured by the camera 304 and process the image to determine the color content in a similar manner as described above with respect to FIGS. 1-3. The controller device 112 may control the light source 110 based on the color content of the image captured by the camera 304 and the lighting/color rules that may be stored in the memory device 204.

In some example embodiments, the communication unit 206 may transmit signals carrying information (e.g., the image captured by the camera 304) to the server 132 and may receive signals from the server 132. For example, the controller unit 202 may use the communication unit 206 to transmit the image captured by the camera 304 and to receive color content of the image determined by the server 132. The controller unit 202 may also use the communication unit 206 to transmit the image 130 received via the communication unit 206 and to receive color content of the image 130 determined by the server 132.

In some example embodiments, the lighting fixture 302 may have more or fewer components than shown without departing from the scope of this disclosure. For example, the lighting fixture 302 may include a driver that provides power to the light sources 110 and 116. In some alternative embodiments, the components of the lighting fixture 302 may have a different configuration than shown without departing from the scope of this disclosure. In some example embodiments, some components of the lighting fixture 302 may be integrated into a single component without departing from the scope of this disclosure.

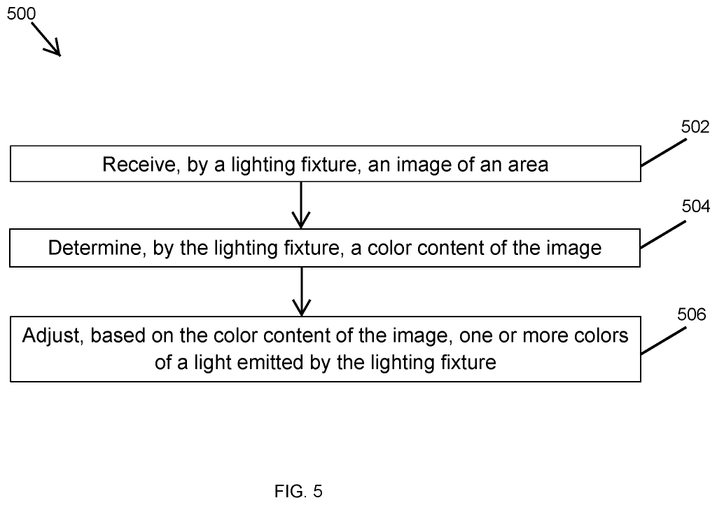

FIG. 5 illustrates a method 500 of lighting adjustment based on an illuminated area according to an example embodiment. Referring to FIGS. 1-5, in some example embodiments, at step 502, the method 500 includes receiving, by a lighting fixture, an image of an area. For example, the lighting fixture 102, 302 may receive the image 130 of the area 108.

In some example embodiments, at step 504, the method 500 may include determining, by the lighting fixture, a color content of the image. For example, the controller device 112 may determine the color content of the image 130 as described above. Alternatively, the control device 104 or the server 132 may determine the color content of the image 130 as described above.

In some example embodiments, at step 506, the method 500 may include adjusting, based on the color content of the image, one or more colors of a light emitted by the lighting fixture. For example, the controller device 112 may adjust light 106 emitted by the lighting fixture 102, 302 based on the color content of the image 130 as described above. The controller device 112 may adjust the light 106 based on the color content of the image 130 in response to a command received from the control device 104.

In some example embodiments, the method 500 may include adjusting the color temperature of the light 106 based on the color content of the image 130 instead of or in addition to adjusting the colors of the light 106. The method 500 may also include adjusting the dim level of the light 106 based on the color content of the image 130.

In some example embodiments, the method 500 may include adjusting, by the controller device 112, the light 106 prior to the image 130 being captured by the remote control device, such as the control device 104. For example, the controller device 112 may adjust the light 106 in response to a command received from the control device 104.

In some alternative embodiments, some of the steps of the method 500 may be performed based on the image captured by the camera 304 instead of based on the image 130. In some example embodiments, one or more steps of the method 500 may be omitted without departing from the scope of this disclosure. In some example embodiments, the method 500 may include additional steps without departing from the scope of this disclosure. In some example embodiments, some of the steps of the method 500 may be performed in a different order than described above without departing from the scope of this disclosure.

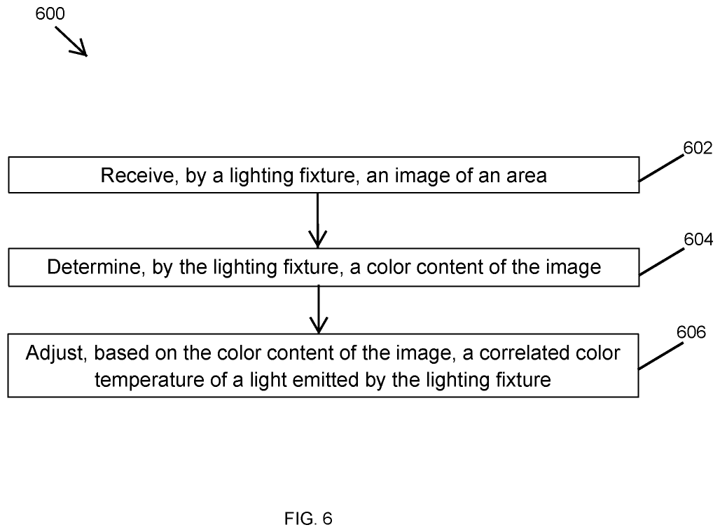

FIG. 6 illustrates a method of lighting adjustment based on an illuminated area according to another example embodiment. Referring to FIGS. 1-4 and 6, in some example embodiments, at step 602, the method 600 includes receiving, by a lighting fixture, an image of an area. For example, the lighting fixture 102, 302 may receive the image 130 of the area 108.

In some example embodiments, at step 604, the method 600 may include determining, by the lighting fixture, a color content of the image. For example, the controller device 112 may determine the color content of the image 130 as described above. Alternatively, the control device 104 or the server 132 may determine the color content of the image 130 as described above.

In some example embodiments, at step 606, the method 600 may include adjusting, based on the color content of the image, a correlated color temperature of a light emitted by the lighting fixture. For example, the controller device 112 may adjust light 106 emitted by the lighting fixture 102, 302 based on the color content of the image 130 as described above. The controller device 112 may adjust the light 106 based on the color content of the image 130 in response to a command received from the control device 104.

In some example embodiments, the method 600 may include adjusting the color of the light 106 based on the color content of the image 130 instead of or in addition to adjusting the color temperature of the light 106. The method 600 may also include adjusting the dim level of the light 106 based on the color content of the image 130.

In some example embodiments, the method 600 may include adjusting, by the controller device 112, the light 106 prior to the image 130 being captured by the remote control device, such as the control device 104. For example, the controller device 112 may adjust the light 106 in response to a command received from the control device 104.

In some alternative embodiments, some of the steps of the method 600 may be performed based on the image captured by the camera 304 instead of based on the image 130. In some example embodiments, one or more steps of the method 600 may be omitted without departing from the scope of this disclosure. In some example embodiments, the method 600 may include additional steps without departing from the scope of this disclosure. In some example embodiments, some of the steps of the method 600 may be performed in a different order than described above without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A lighting fixture, comprising:
a light source configured to emit a light toward an area;
a receiver configured to receive an image of the area; and
a controller device configured to adjust a color or a color temperature of the light based on at least color content of the image.

2. The lighting fixture of claim 1, wherein the controller device is configured to determine the color content of the image.

3. The lighting fixture of claim 1, wherein the controller device is configured to receive the color content of the image from a server.

4. The lighting fixture of claim 3, wherein the controller device is configured to transmit the image to the server for the server to determine the color content of the image.

5. The lighting fixture of claim 1, wherein the controller device is configured to adjust the color or the color temperature of the light in response to a command received from a remote control device.

6. The lighting fixture of claim 5, wherein the receiver is configured to receive the image of the area from the remote control device.

7. The lighting fixture of claim 5, wherein, prior to the image of the area being captured, the controller device is configured to adjust the light to reduce an impact of the light on the image of the area in response to a command received from a remote control device.

8. The lighting fixture of claim 5, wherein the controller device is further configured to adjust a dim level of the light based on the color content of the image.

9. The lighting fixture of claim 1, wherein the controller device is configured to adjust the color or the color temperature of the light emitted by the light source further based on a lighting rule associating color contents with colors or color temperatures.

10. A lighting fixture, comprising:
a light source configured to emit a light toward an area;
a camera configured to capture an image of the area; and
a controller device configured to adjust a color or a color temperature of the light based on at least color content of the image.

11. The lighting fixture of claim 10, wherein the controller device is configured to determine the color content of the image.

12. The lighting fixture of claim 10, wherein the controller device is configured to receive the color content of the image from a server.

13. The lighting fixture of claim 12, wherein the controller device is configured to transmit the image to the server for the server to determine the color content of the image.

14. The lighting fixture of claim 10, wherein, prior to the camera capturing the image of the area, the controller device is configured to adjust the light to reduce an impact of the light on the image of the area.

15. The lighting fixture of claim 10, wherein the camera is configured to capture the image of the area in response to a command received from a remote control device.

16. The lighting fixture of claim 10, wherein the controller device is configured to adjust the color or the color temperature of the light emitted by the light source further based on a lighting rule associating color contents with colors or color temperatures.

17. A method of adjusting a light provided by a lighting fixture, the method comprising:
receiving, by the lighting fixture, an image of an area from a camera;
determining, by a controller device of the lighting fixture, a color content of the image; and
adjusting, by the controller device of the lighting fixture, a color of the light or a color temperature of the light based on the color content of the image.

18. The method of claim 17, further comprising, adjusting, by the controller device, prior to the camera capturing the image of the area, the light to reduce an impact of the light on the image before the image is captured by the camera.

19. The method of claim 17, further comprising, receiving, by the lighting fixture, a command from a remote control device, wherein the controller device is configured to adjust the color of the light or the color temperature of the light based on the color content of the image in response to the command.

20. The method of claim 17, wherein the controller device is configured to adjust the color of the light or the color temperature of the light further based on a lighting rule associating color contents with colors or color temperatures.
